(19) United States
(12) Patent Application Publication
(10) Pub. No.: US 2015/0016581 A1
(43) Pub. Date: Jan. 15, 2015

(54) SYSTEM FOR REMOVING THE RESIDUAL POWER OF A PRESSURISED WATER NUCLEAR REACTOR

(71) Applicant: SOCIÉTÉ TECHNIQUE POUR L'ENERGIE ATOMIQUE TECHNICATOME, Villiers le Bacle (FR)

(72) Inventor: Charles Fribourg, Antony (FR)

(21) Appl. No.: 14/372,674

(22) PCT Filed: Jan. 17, 2013
(86) PCT No.: PCT/EP2013/050836

§ 371 Date: Jul. 16, 2014

(30) Foreign Application Priority Data
Jan. 18, 2012 (FR) 1250513

(51) Int. Cl. G21C 15/18; G21C 13/02

(52) U.S. Cl. CPC G21C 15/18; G21C 13/02
USPC 376/241

(57) ABSTRACT

A system for discharging the residual power of a nuclear reactor includes: a containment vessel incorporating a primary vessel including the core; a water reserve; a steam source wherein the heated primary water circulates and heats the secondary water circulating in the steam source; a condenser in the containment vessel including: a recovery unit; a condenser link linked to an intermediate water circuit and ensuring the circulation of the intermediate water between the water reserve and the condenser; a hot link ensuring the circulation of the steam to the condenser; a cold link ensuring the circulation, by gravity, of the water from the recovery unit to the secondary water inlet of the steam source; a heat recovery unit on the intermediate water circuit, the heat recovery unit being traversed by a feed water circuit, the feed water capable of heating up by thermal contact with the intermediate water circulating through the heat recovery unit.

This invention relates to the field of pressurised water nuclear reactors and is more particularly applicable to removing the residual power from the core of this reactor after this reactor has been shutdown.

In general, when a reactor is shutdown by introducing strong negative-reactivity into the core, the number of fissions in the core very quickly becomes negligible after a period of the order of a few seconds. On the other hand, the radioactivity of fission products that developed in the core during the normal operating period continues to release high power that can represent 6-7% of the operating power of the reactor at the time of its shutdown.

When a few hours have elapsed after shutdown, the residual power is still 1-2% of the operating power of the reactor, and then reduces relatively slowly afterwards; this residual power has to be removed. Therefore means of removing this residual power under all circumstances are essential, otherwise there is a risk of a core meltdown. It is known that this can be achieved by using special devices for removing residual power from the core, to take over from steam generators in the case of accident conditions, the steam generators being used during a normal shutdown of the reactor.

The residual power of nuclear reactor cores in the case of an accident is conventionally removed using standby systems making use of active means, for example based on the principle of cooling the primary coolant using steam dumps located on the secondary, with water re-supplied to the steam generator by active means (pumps).

Such safety cooling systems using pump type active means require the input of outside energy particularly to make the pumps operate. Since the reactor is shut down, it no longer generates electricity and therefore standby sources of energy have to be used (for example diesel generator) so that the pumps can operate. It can be easily understood that the nature of these active sources will reduce the operational reliability of these safety cooling systems.

Fully passive devices are known that can be used for removing residual power in the logic of a total loss of the electricity power supply.

Thus, document U.S. Pat. No. 6,795,518 discloses the characteristics of an integrated pressurised water reactor (i.e. the steam generator is in the reactor vessel) comprising a passive device for removing residual power using steam output from the secondary side of the steam generator in the reactor vessel. Steam output from the steam generator condenses on the tubes of a condenser by cooling with water contained in an inertial tank; water originating from the inertial tank circulates by natural circulation, while steam also circulates naturally between the SG and the external condenser. This system is triggered passively by a valve that opens without the input of any outside energy. Nevertheless, there are some problems with such an architecture.

The passive residual power removing system according to document U.S. Pat. No. 6,795,518 uses isolating valves to isolate the condenser from the containment vessel to prevent any risk of radioactivity being dispersed outside the containment vessel. As a reminder, the containment vessel contains the main NSSS equipment, protects this equipment from external accidents (earthquakes, projectiles, flooding, etc.) and forms the third barrier preventing the release of radioactive products into the environment beyond the fuel cladding and the reactor vessel. If a break occurs on links connecting the containment vessel and the condenser, the isolating valves have to be closed off to prevent secondary water from pouring outside the containment vessel (particularly in the inertial tank). Such closing automatically stops the residual power removing system from operating. Similarly, if there is no electricity power supply, the isolating valves are closed by default (so as to isolate the containment); when the valves are closed, the residual power removing system can no longer function.

As soon as the residual power removing system requires a start-up phase, even if it is passive, then special purpose monitoring systems have to be installed in order to periodically test the power removing system to assure that it operates correctly if the electricity power supply to core cooling systems is lost.

Secondly, the system start-up phase introduces an uncertainty that monitoring systems can never entirely eliminate, no matter how efficient they may be.

Finally, passive triggering of such a power removing system takes place when several conditions (temperature, pressure, etc.) are satisfied. Thus, there is a delay in activating the power removing system between when the reactor is shut down and when activation conditions are satisfied. This activation time is of the order of several tens of minutes, during which there is no cooling to remove residual power from the reactor.

In this context, this invention discloses a system to remove residual power from a pressurised water nuclear reactor and a reactor in which such a system is installed in order to remove the residual power, including in the case of a secondary water line break in the steam generator supplying the turbine, said system does not have an isolating valve between the containment vessel and the condenser, can be tested during operation of the reactor under power and does not require any activation time or operator action.

To achieve this, the invention discloses a system for removing residual power from a nuclear reactor comprising a containment vessel including a primary containment including the reactor core, said system including:
a water reserve;
at least one steam source adapted to be contained in the reactor containment vessel in which primary water heated by the core circulates and heats the secondary water circulating in said steam source;
at least one condenser designed to be housed in the containment vessel including:
   a recovery unit capable of recovering secondary water condensed by the condenser, and;
   a condenser line connected to an intermediate water circuit and capable of circulating said intermediate water in a closed circuit between the water reserve and the condenser;
a hot line carrying natural circulation of the steam output from the steam source to said at least one condenser, said at least one condenser being capable of condensing steam circulating in the hot line by thermal contact with the intermediate water circulating in said condenser line;
a cold line circulating water output from the condenser recovery unit to the secondary water inlet of the steam source, by gravity;
at least one heat recovery unit placed on the intermediate water circuit, said at least one heat recovery unit being passed through by a feedwater circuit, said feedwater possibly being heated by thermal contact with intermediate water circulating through said heat recovery unit.

Another purpose of this invention is a pressurised water nuclear reactor comprising:
a containment vessel comprising a primary containment including the reactor core;
a residual power removing system from said nuclear reactor comprising:
   an intermediate water reserve;
   at least one steam source housed in the containment vessel of the reactor inside which primary water heated by the core and secondary water heated by the primary water circulate;
   at least one condenser housed in the containment vessel and arranged at a higher elevation than said steam source, said condenser including:
      a recovery unit to recover secondary water condensed by the condenser;
      a condenser line;
   an intermediate water circuit to circulate said intermediate water in closed circuit between the intermediate water reserve and the condenser through the condenser line;
   a hot line connecting the steam outlet from the steam source with said at least one condenser such that said at least one condenser condenses steam circulating in the hot line by thermal contact with intermediate water circulating in said condenser line;
   a cold link connecting the condenser recovery unit with the secondary water inlet of the steam source;
   a feedwater circuit;
   at least one heat recovery unit placed on the intermediate water circuit and arranged at a higher elevation than said condenser, said at least one heat recovery unit being passed through by a feedwater circuit, said feedwater being heated by thermal contact with the intermediate water circulating through said heat recovery unit.

The residual power removing system and the reactor according to the invention may also have one or several of the following characteristics taken individually or in any technical possible combination:
said at least one heat recovery unit is a condenser or a heat exchanger or a U-shaped heat exchanger;
said at least one heat recovery unit is adapted to be housed outside the containment vessel;
said at least one heat recovery unit is housed in the water reserve;

said at least one heat recovery unit comprises thermally insulated walls;
said steam source is a once-through steam generator and/or a methodical type steam generator and/or a micro-channel steam generator;
said system is adapted to operate permanently as long as the reactor is in operation, generating a loss of thermal efficiency of less than 3% of the nominal power during operation of the reactor and advantageously less than 1% of the nominal power during operation of the reactor;
said steam source is arranged in the primary containment above the core to force natural circulation of the primary water;
said water reserve is arranged on the side of or above said containment vessel;
said steam source is housed in the primary containment of the reactor;
said steam source is a dedicated source;

said system is designed so that it can dissipate a residual power equal to less than or equal to 3% of the nominal power of the reactor;
said condenser is located close to the side walls of said containment vessel; thus, proximity refers to a distance between the condenser and the wall of the containment vessel equal to the order of 1 meter or even less than 1 meter.

It should be noted that the residual power removing system has no passive or active open/close valve that would open during the change from normal operation to accident operation during which in particular the normal core cooling system is unavailable (for example in the case of the loss of an electrical power supply), the principle of the invention depending on permanent operation of the residual power removing system.

Another purpose of this invention is a nuclear reactor comprising a containment vessel containing a primary containment including the reactor core and a residual power removing system according to the invention, said reactor being characterised in that said condenser is housed close to the side walls of said containment vessel.

Other characteristics and advantages of the invention will become clear after reading the description given below that is given for guidance and is in no way limitative:

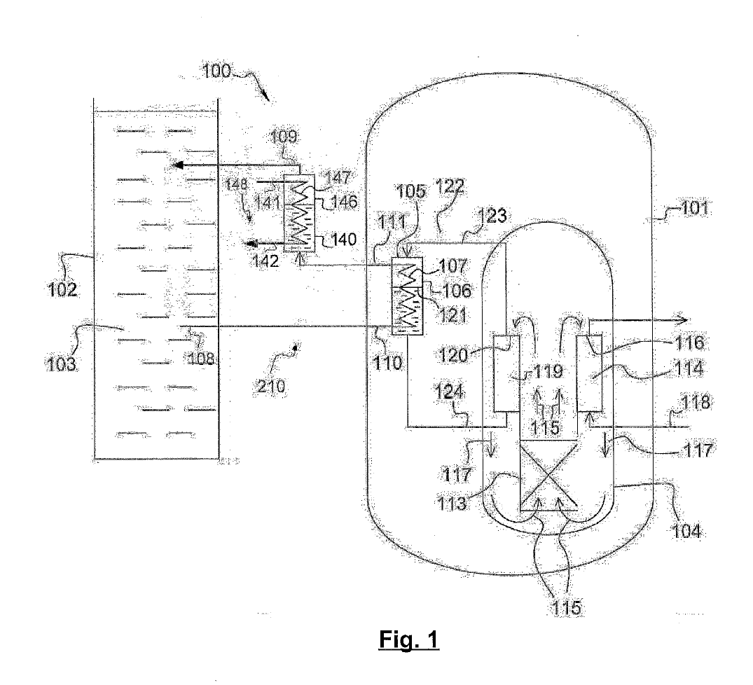

FIG. 1 diagrammatically shows a first embodiment of a passive residual power removing system according to the invention integrated into a nuclear reactor;

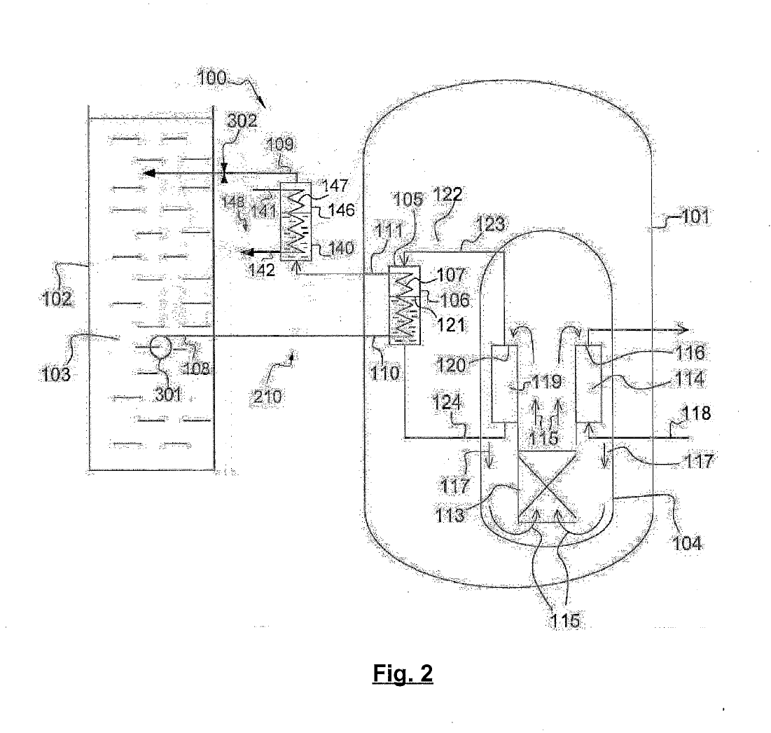

FIG. 2 shows a variant of the first embodiment shown in FIG. 1;

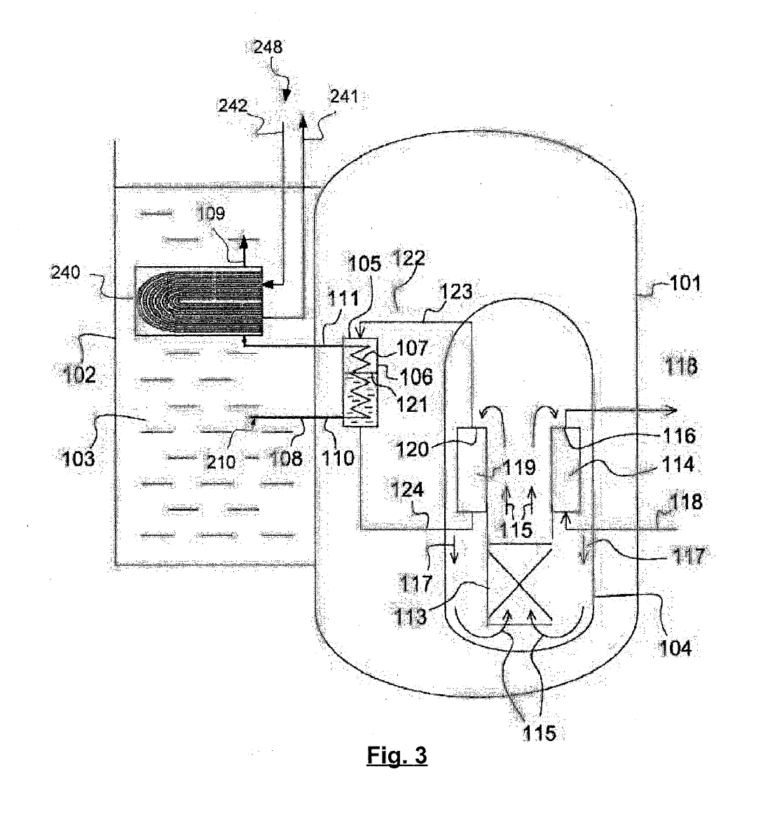

FIG. 3 diagrammatically shows a second embodiment of a passive residual power removing system according to the invention, integrated into a nuclear reactor.

Therefore FIG. 1 diagrammatically shows a nuclear reactor 100 according to the invention that comprises two main elements:
a containment vessel 101;
a water reserve 102.

The water reserve 102 in this figure is shown on the side of the containment 101 but it is understood that it can be placed around or above the containment 101. In this first embodiment, the water reserve 102 is not directly adjacent to the containment vessel 101. This ordinary water reserve 102 must contain a large volume of water 103, particularly large because the objective is to delay any human action. The water in the water reserve 102 is ordinary water such that the water reserve can be filled up when it is empty; this is done by using dry ducts (not shown) to facilitate remote filling. It should be noted that the water reserve 102 is not under pressure such that the water at the highest level in this reserve 102 is at approximately atmospheric pressure.

The containment vessel 101 comprises:
a primary containment 104;
at least one condenser 105.

As mentioned above, the containment vessel contains the main elements of the NSSS, protects them from external accidents (earthquake, projectiles, flooding, etc.) and forms the third barrier preventing the release of radioactive products into the environment.

The condenser 105 is formed by a recovery unit 106 (i.e. a receptacle capable of receiving condensed water from the condenser) and a condenser line 107 located inside the recovery unit 106. Both ends of the condenser line 107 are connected to nozzles 110 and 111, the assembly forming an intermediate water circulation loop 210, the ends 109 and 108 of which penetrate into the water reserve 102, the end 109 being higher than the end 108.

The primary containment 104 forms the pressure containment of the nuclear reactor 100; the nuclear reactor 100 is indifferently an integrated type reactor, a loop-type reactor or a compact-type reactor.

According to a first embodiment shown in FIG. 1, the nuclear reactor 100 is an integrated type reactor such that the reactor vessel 104 comprises the following in a known manner:
the reactor core 113 composed of nuclear fuel assemblies is located near the bottom and in the middle of the primary containment 104;
at least one steam generator 114 located above the core 113, around the periphery of the primary containment 104.

During normal operation of the reactor 100 (i.e. when the reactor is operating under power to produce steam), a primary water circulation in what is called the “primary system” is organised inside the primary containment 104 to evacuate heat from the core to the steam generator 114. Therefore there is an upwards central movement (arrows 115) of the coolant that passes successively in the core 113 and then enters the steam generator 114 through a primary inlet 116 located on the upper part of the steam generator 114, the coolant then being returned into the primary containment 104 around its periphery to drop below the central core along a downwards peripheral movement (arrows 117).

Primary circulation pumps (not shown) are installed in or around the primary containment 104 to provide the energy necessary to the primary water, to circulate it throughout the entire primary containment 104.

A secondary circuit 118 connects the steam generator 114 to a turbine that drives an alternator to transform heat from the primary system into an electrical current. More precisely, this heat in the steam generator 114 transforms water circulating in the secondary circuit 118 driven by secondary pumps into steam. The steam that drives the turbine is then returned to the liquid state in a condenser (not shown).

In accordance with the first embodiment of the invention, the primary containment 104 also comprises a steam source 119, for example such as a steam generator (SG), also located at the periphery of the primary containment 104 and more precisely near the top of it above the core 113.

In this first embodiment, this steam source 119 is different in that it is dedicated to the removing of residual power; in other words, the dedicated steam source 119 does not participate in supplying steam to the turbine.

In this first embodiment, the steam source 119 is preferably a once-through steam generator. A once-through steam generator means a steam generator in which secondary water (when it circulates in the generator) passes through the steam generator once; in other words, all secondary water (in the form of steam and/or liquid) enters and exits from the generator once and it is not possible to re-circulate it in the steam generator; for example, this type of once-through generator is unlike generators composed of a bundle of U-tubes and surrounded by a cylindrical shell that contains cyclone separators; in the case of a multi-pass (or recirculation) steam generator, some of the secondary water located between the shell and the tubes is vaporised while the other non-vaporised part returns into the annular space of the shell. This type of multi-pass generator has the enormous disadvantage that it is very large and therefore not suitable for use as a dedicated generator used solely for the discharge of residual power.

The once-through steam generator 119 is preferably a methodical steam generator; a methodical steam generator is a generator in which the primary water and secondary water currents circulate in opposite directions. We will discuss the advantages of a methodical steam generator later.

The steam generator 119 is preferably a micro-channel steam generator formed by an assembly of engraved plates diffusion welded to each other.

During normal operation of the reactor under power, primary water heated by the core 113 follows its upwards movement (arrows 115) and then also enters the dedicated steam source 119 through a primary input 120 located on the top part of the steam source 119, the fluid then being returned around the periphery of the primary containment 104 to drop below the core 113 by a peripheral downwards movement (arrows 117).

Unlike the steam generator 114, the secondary loop 122 passing through the steam source 119 is not connected to the turbine. On the other hand, this secondary loop 122 connects the steam source 119 and the condenser 105 in which the secondary water located in the recovery unit 106 can circulate in closed loop.

The secondary loop 122 is composed of a hot leg 123 and a cold leg 124.

According to another embodiment of the invention, the steam source 119 is obtained by making branch connections on the hot leg and the cold leg of the secondary circuit 118 connecting the steam generator 114 to the turbine (not shown). In this embodiment, the branch connections on the hot leg and the cold leg of the secondary circuit 118 are connected to the condenser 105 so as to form the intermediate loop.

It should be noted that the recovery unit 106 of the condenser 105 is located above (i.e. higher) than the steam source 119 such that water from the recovery unit 106 drops by gravity through the cold leg 124 into the steam source 119.

Thus, during operation of the reactor under power, primary water heated by the core 115 passes through the steam source 119 and exchanges heat with secondary water circulating inside said source.

“Cold” secondary water from the recovery unit 106 and circulating in the cold leg 124 penetrates into the steam source 119 and evaporates in contact with the primary water heated by the core 115. Secondary steam then rises in the hot leg 123. Steam originating from the steam source 119 condenses in contact with the condenser line 107 by thermal contact with intermediate water from the water reserve 102 and circulating in the condenser line 107 through the intermediate water circuit 210; the condensed steam is recovered in the recovery unit 106 and then reinjected into the steam source 119.

Since the steam temperature is high (dependent on the primary water temperature that is of the order of 300° C.), it will trigger partial boiling of intermediate water from the reserve 102 circulating in the condenser line 107. This partial boiling makes it possible to circulate intermediate water by natural convection in the intermediate loop 210 formed by the nozzles 108, 110, the condenser line 107 and the nozzles 111, 109 in which the intermediate water is circulating.

Intermediate water circulating in the nozzle 111 (i.e. at the outlet from the condenser 105) is water in its two-phase form. It passes through a heat recovery unit 140 that exchanges heat with water circulating in a fourth loop 148 called the supply loop.

In this first embodiment shown in FIG. 1, the heat recovery unit 140 is a condenser comprising a recovery unit 146 (i.e. a receptacle capable of receiving intermediate water condensed by the condenser) and a condenser line 147 housed inside the recovery unit 146. The two ends of the condenser line 147 are connected to nozzles 141 and 142, and this assembly forms the fourth loop 148 called the supply loop.

According to another embodiment, the heat recovery unit is a heat exchanger comprising a plurality of pipes inside which intermediate water circulates, said pipes being immersed in feedwater passing through the heat exchanger.

Thus, during operation of the reactor under power, two-phase intermediate water heated by secondary water via the condenser 105 passes through the condenser 140 and exchanges heat with the feedwater circulating inside the condenser line 147.

The two-phase intermediate water condenses in contact with the condenser line 147 by thermal contact with feedwater circulating in the feed loop 148. The condensed and therefore cooled intermediate water is recovered in the recovery unit 146 and is then reinjected into the water reserve 102 through the nozzle 109 forming the end of the intermediate loop 210. Therefore the feedwater at the outlet from the heat recovery unit 140 (i.e. in the nozzle 141) is heated water that can be exploited and used for various applications.

It should be noted that the water level 103 in the water reserve 102 is above the low nozzle 108 and the high nozzle 109 of the intermediate water loop 210 to obtain a maximum water volume and thus to guarantee an intermediate water supply to the intermediate loop 210 for as long as possible if the normal reactor cooling system is shut down.

During normal operation of the reactor, there is no partial boiling of the water 103 contained in the reserve 102 because the intermediate water reinjected into the reserve 102 is cooled water.

Therefore, the residual power removing system operates with four loops, three of which are natural circulation loops: there is a primary loop in which primary water circulates through the core and the primary side of the steam generator 119, a secondary loop in which secondary water circulates through the secondary side of the steam generator 119 and the condenser 105, and a tertiary loop called the intermediate loop in which intermediate water from the reserve 102 circulates. The fourth loop is the feedwater loop, which is circulated by means of a pump (not shown).

In summary, during normal operation under power, primary water circulates in the primary containment 104, this primary water is heated by heat exchanges with the reactor core 113. The heated primary water is cooled by heat exchanges with the steam generator 114 of which the steam produced is used to actuate turbines and generate electricity, and with the steam generator 119 of the permanently operating residual power removing system.

Consequently, such a power removing system that operates permanently during normal operation of the reactor under power reduces the efficiency of the turbine, because part of the heat produced by the reactor core 113 is removed through the residual power removing system and is not used for the generation of electrical energy. The power removing system according to the invention is sized to cause a limited loss of efficiency, for example of the order of 2 to 3% of the nominal power during operation of the reactor.

However, this loss of efficiency is minimised through the use of the heat recovery unit 140 that makes it possible to use the power dissipated by the residual power removing system during operation of the reactor. Thus, reuse of the power dissipated by the system according to the invention can make the loss of efficiency negligible, i.e. less than 1% of the nominal power of the reactor.

If the normal core cooling system (not described in the description) is not available, for example in the case of a loss of the electrical power supply following an incident, the core shutdown is triggered by the control rods dropping introducing a strong negative-reactivity into the core; the number of fissions in the core drops very quickly at the end of a period of a few seconds. On the other hand, the radioactivity of fission products that have developed in the core during the normal operating period continues to release high power that is denoted by the term core decay heat.

At the time that the reactor is shut down, this decay heat represents 6 to 7% of the operating power of the reactor. With the passive system for discharge of decay heat according to the invention, as soon as the reactor is shut down (i.e. without any activation time), the system is capable of removing heat of the order of 2 to 3% of the operating power of the reactor due to natural circulation of primary water, secondary and tertiary water.

If the electrical power supply is lost, the removing system according to the invention will continue to operate based on the same principle as described above for normal operation of the reactor, except for feedwater that will no longer circulate in the feed loop due to the loss of the power supply to the feedwater circulation pump. Intermediate water reinjected into the reserve 102 will then no longer be cooled, which can cause partial boiling of the water 103 in the reserve and therefore a drop in water level 103. When the level of the water reserve 102 drops, the reserve 102 will simply be topped up with ordinary water (treated or not) so that the water level remains above the condenser 105. Thus, the intermediate water supply to the condenser 105 by gravity is preserved.

Thus, when the reactor is shut down, the system will no longer be capable of removing all residual power (equivalent to 6-7% of the operating power of the reactor). Consequently, the core temperature will increase for a few hours, in other words as long as the reactor residual power is greater than the residual power discharge capacity of the system according to the invention.

On the other hand, a few hours after the shutdown, residual power only accounts for 1 to 2% of the operating power of the reactor. Starting from this moment, the residual power removing system according to the invention will be capable of passively continuously cool the core.

During the first few hours after the shutdown, the temperature of the reactor will increase to a limited extent but will remain well below the various critical thresholds.

According to one variant embodiment of this first embodiment, the loss of efficiency of the reactor may advantageous be minimised particularly by an improvement in heat exchanges inside the heat recovery unit 140.

FIG. 2 shows this variant. Heat exchanges between the feedwater and the intermediate water can be improved by pressurising the intermediate water in the intermediate loop 210 by means of pumps 301, for example of the mixed flow type or the axial flow type pump. Such a pump 301 can pressurise the intermediate circuit to approximately 2 to 3 bars or even more, so as to obtain an intermediate water boiling temperature of more than 100° C. Intermediate water can thus store more heat in contact with secondary water and therefore restore more heat to the feedwater through the heat recovery unit 140. A diaphragm 302 downstream from the recovery unit exchanger 140 will assure the required pressurisation to raise the fluid temperature above 100° C. This usage variant is particularly interesting for an application for the cogeneration of electricity/heat.

If an accident occurs and the electrical power supply to the intermediate water pressurisation pump 301 is lost, the residual power removing system is in the same configuration as described above (i.e. with reference to FIG. 1) and circulation of intermediate water in the intermediate loop is set up by the thermosiphon phenomenon (i.e. without pressurisation).

FIG. 3 shows a second embodiment of the power removing system according to the invention. The residual power removing system 200 shown in FIG. 3 is identical to the residual power removing system 100 described previously with reference to FIG. 1, except for the characteristics described below. Elements in common with the first embodiment described above have the same reference numbers unless mentioned otherwise.

In this second embodiment, water 103 in the water reserve 102 is in contact with the containment vessel 101. In the same way as in the previous embodiment, the water reserve 102 is shown on the side of the containment 101, but obviously it may be placed all around or above the containment 101.

In this second embodiment, the heat recovery unit 240 is a heat exchanger immersed directly in the water 103 in the water reserve 102. Consequently, it is provided with a thermally insulated wall preventing any dissipation of heat from the intermediate water circulating inside the exchanger 240 with water 103 in the water reserve 102, the purpose being to recover a maximum amount of heat from intermediate water. Similarly, the part of the nozzle 111 immersed in the water 102 in the reserve is also thermally insulated.

The heat exchanger 240 is formed from a plurality of tubes inside which feedwater circulates. These tubes are immersed in intermediate water passing through the heat exchanger 240.

The tubes 246 adapted to contain feedwater are connected to nozzles 241 and 242 and thus form the feedwater loop 248. The nozzles 241 and 242 are immersed in the water 103 in the reserve 102 and are connected to a feed circuit outside the water reserve 102. The nozzles 241 and 242 advantageously comprise insulation means to prevent heat exchanges between feedwater circulating in the nozzles 241, 242 and the surrounding water 103 in the reserve 102. For example, the insulating means may be an insulating nozzle (not shown) forming a dry conduit around each nozzle or around the two nozzles.

The number of tubes 246, and the length and diameter of the tubes 246 are determined such that feedwater circulating inside the tubes 246 does not circulate too fast so as to optimise heat exchanges with intermediate water. According to one non-limitative embodiment, the number of tubes and the diameter are defined such that circulation velocity of the feedwater flow is at the limit of the turbulent flow velocity of water.

According to one embodiment of the heat exchanger 240, the tubes 246 are U-shaped. This shape maximises the heat exchange area while minimising the size and more particularly the height of the exchanger 240 in the water reserve 102.

As mentioned above, the steam source 119 is preferably a methodical steam generator. By using cross currents, steam is superheated at the outlet from the steam generator because the primary and secondary fluids intersect at their maximum temperatures. This arrangement further improves the heat exchange efficiency of the system.

According to one embodiment of the invention, the structure of the steam generator 114 is identical to the structure of the dedicated steam source 119.

The condenser 105 is preferably placed as close as possible to the wall of the containment vessel 101 to limit risks of breaks on nozzles 110 and 111 due to external aggression. Furthermore, the diameters of these nozzles 110, 111 will be chosen to achieve a sufficient flow to evacuate residual power and to facilitate initiation and maintenance of natural circulation in the secondary loop.

Obviously, the invention is not limited to the embodiment that has just been described.

Thus, although a single condenser has been described, it is obvious that the invention is applicable to the case of several condensers located in the containment vessel so that accident situations can be handled by applying a defined failure situation or a line maintenance situation.

Similarly, the reactor according to the invention may comprise several dedicated steam sources and several steam generators.

The invention has been described particularly for an integrated nuclear reactor. However, the invention is also applicable to a loop nuclear reactor. The production principle is identical to that described above except for the fact that the steam source(s) for the residual power removing system and the steam generators for the normal cooling system of the reactor are located outside the primary containment. In the same way as with the embodiments described above, the steam source of the residual power removing system may be a dedicated source or it may be formed by means of branch connections made on the hot legs and cold legs of the secondary circuit of steam generators used for steam production.

To summarise the advantages of the invention, the proposed solution is based on permanent cooling (i.e. during operation and during shutdown of the reactor) in closed loop in natural circulation between a once-through methodical steam source that may or may not be dedicated to the residual power discharge function (located inside or outside the primary containment of the reactor) and a condenser outside the NSSS unit and located in the containment vessel. This condenser is itself cooled in natural circulation by means of a large water volume (for example a nearby lake) outside the containment vessel. The secondary fluid remains confined between the steam source and the condenser. The residual power discharge function is done passively and permanently. Thus, the system according to the invention can eliminate:
the system activation time,
uncertainty about activation of the system, which may be jeopardised by a decision by the operator who can make a mistake, or by an automatic system that is subject to failure;
and more generally uncertainty about correct operation of the system.

Furthermore, due to permanent operation of the system according to the invention, there is no need to perform specific periodic tests or to provide a device to test the system; if a failure of the system occurs, it will be quickly identified because the system operates permanently; in this case:
the reactor is shut down;
the system is repaired;
normal operation of the reactor is resumed afterwards.

1. A pressurised water nuclear reactor comprising:
a containment vessel comprising a primary containment including a reactor core;
a residual power removing system from said nuclear reactor comprising:
an intermediate water reserve;
at least one steam source housed in the containment vessel of the reactor inside which primary water heated by the core and secondary water heated by the primary water circulate;
at least one condenser housed in the containment vessel and arranged at a higher elevation than said steam source, said condenser including:
a recovery unit to recover secondary water condensed by the condenser;
a condenser line;
an intermediate water circuit to circulate intermediate water of the intermediate water reserve in closed circuit between the intermediate water reserve and the condenser through the condenser line;
a hot line connecting a steam outlet from the steam source with said at least one condenser such that said at least one condenser condenses steam circulating in the hot line by thermal contact with the intermediate water circulating in said condenser line;
a cold line connecting the condenser recovery unit with a secondary water inlet of the steam source;
a feedwater circuit;
at least one heat recovery unit placed on the intermediate water circuit and arranged at a higher elevation than said condenser, said at least one heat recovery unit being passed through by a feedwater circuit providing feedwater, said feedwater being heated by thermal contact with the intermediate water circulating through said heat recovery unit.

2. The nuclear reactor according to claim 1, wherein said at least one heat recovery unit is a condenser or a heat exchanger or a U-shaped heat exchanger.

3. The nuclear reactor according to claim 1, wherein said at least one heat recovery unit is housed outside the containment vessel.

4. The nuclear reactor according to claim 1, wherein said at least one heat recovery unit is housed in the water reserve.

5. The nuclear reactor according to claim 1, wherein said at least one heat recovery unit comprises thermally insulated walls.

6. The nuclear reactor according to claim 1, wherein said steam source is a once-through steam generator and/or a methodical type steam generator and/or a micro-channel steam generator.

7. The nuclear reactor according to claim 1, wherein said steam source is arranged in the primary containment above the core to force natural circulation of the primary water.

8. The nuclear reactor according to claim 1, wherein said water reserve is arranged on the side of or above said containment vessel.

9. The nuclear reactor according to claim 1, wherein said steam source is housed in the primary containment of the reactor.

10. The nuclear reactor according to claim 1, wherein said steam source is a dedicated source.

11. The nuclear reactor according to claim 1, wherein said condenser is located close to side walls of said containment vessel.
